(19) United States
(12) Patent Application Publication
(10) Pub. No.: US 2005/0133465 A1
(43) Pub. Date: Jun. 23, 2005

(54) Vibratory screen assembly and method of manufacture

(75) Inventors: Mitchell J. Derrick, Houston, TX (US); Robert G. Derrick, Orchard Park, NJ (US); James A. Mooney, Tonawanda, NY (US)

Correspondence Address: CONLEY ROSE, P.C., P. O. BOX 3267, HOUSTON, TX, 77253-3267, US

(73) Assignee: Derrick Corporation, Buffalo, NY (US)

(21) Appl. No.: 10/977,782

(22) Filed: Oct. 29, 2004

Related U.S. Application Data
(63) Continuation-in-part of application No. 10/167,996, filed on Jun. 12, 2002.

(51) Int. Cl. B01D 33/03

(52) U.S. Cl. 210/780; 210/384

(57) ABSTRACT

A screen assembly comprising a support, a screen comprising peaks and troughs, and a coating on at least a portion of a plurality of the peaks. An apparatus for screening material comprising a frame, a motor mounted to the frame, a screen assembly supported by the frame, a chamber beneath the screen assembly adapted to be placed intermittently at less than atmospheric pressure, a screen formed in an undulating shape comprising a plurality of peaks and troughs, and a coating on at least a portion of a plurality of the peaks.

### CROSS-REFERENCE TO RELATED APPLICATIONS

The present application is a continuation-in-part of application Ser. No. 10/167,996, filed Jun. 12, 2002.

### STATEMENT REGARDING FEDERALLY SPONSORED RESEARCH OR DEVELOPMENT

Not Applicable

### BACKGROUND INFORMATION

Embodiments of the present invention relate to a vibratory screen and a method for manufacturing screens. Such screens may be employed to withdraw liquid and fine particles from a slurry and also to cause coarse particles which are not withdrawn from the slurry to be relatively dry.

By way of background, in the oil drilling process, drilling mud is used for its conventional purposes of lubricating the drill and carrying drilled material to the surface. The combination of drilling mud and drilled material is a slurry of fine drilling mud solids, coarse drilled material particles and liquid. The primary liquid portion of the drilling mud may be oil or water, depending on whether the drilling mud is water-based or oil-based. It is desirable to recover the drilling mud for reuse because it can be expensive. It is also desirable to withdraw the liquid from the coarse drilled material particles so that the latter can be disposed of in an efficient manner.

### BRIEF SUMMARY OF THE SPECIFIC EMBODIMENTS

It is accordingly an object of embodiments of the present invention to provide a screen assembly having a support having upper and lower surfaces and a plurality of apertures between the upper and lower surfaces; an undulating screen comprising peaks and troughs, such that the peaks are spaced apart from the upper surface of the support; and a coating that restricts the passage of air on at least a portion of the peaks of the screen.

It is further an object of embodiments of the present invention to provide an apparatus for screening material comprising a frame; a motor mounted to the frame and adapted for supplying vibration to the frame; a screen assembly as described above supported by the frame; and a chamber beneath the screen assembly adapted to be intermittently subjected to a suction.

### BRIEF DESCRIPTION OF THE DRAWINGS

FIG. 1 is a fragmentary side elevational view of the vibratory screening machine taken substantially in the direction of arrows 1-1 of FIG. 3 and showing primarily the movable frame;

FIG. 1A is a fragmentary end elevational view of the machine taken substantially in the direction of arrows 1A-1A of FIG. 1;

FIG. 2 is a fragmentary side elevational view of the vibratory screening machine taken substantially in the direction of arrows 2-2 of FIG. 3;

FIG. 2A is a fragmentary perspective view of the structure of the side wall of the movable frame shown in FIG. 2;

FIG. 3 is an end elevational view of the vibratory screening machine taken substantially in the direction of arrows 3-3 of FIG. 1;

FIG. 3A is a fragmentary perspective view of the resilient connections between the stationary frame and the movable frame at the outlet end of the machine;

FIG. 4 is a view taken substantially in the direction of arrows 4-4 of FIG. 1 and showing various structural features of the movable frame including the screens;

FIG. 4A is a cross sectional view of the movable frame taken substantially along line 4A-4A of FIG. 4;

FIG. 4B is a fragmentary perspective view of the flat screen at the outlet end of the movable frame;

FIG. 4C is a fragmentary perspective view of one of the undulating screens which is located at the slurry entry and central portions of the movable frame;

FIG. 4D is a fragmentary bottom plan view of the perforated frame of each of the screens showing the resilient plastic sealing bead on the periphery of the underside of the frame;

FIG. 5 is a plan view of the suction-pressure pan mounted on the underside of the machine to which the duckbill valves are attached, with this view being taken substantially in the direction of arrows 5-5 of FIG. 1 without showing anything other than the pan;

FIG. 6 is a fragmentary perspective enlarged view showing portions of the bed of the machine onto which the screens and the suction-pressure pan are attached;

FIG. 7A is a fragmentary end elevational view showing the flat screen which is mounted at the outlet end of the movable frame;

FIG. 7B is a fragmentary enlarged detail of the seal between the screen and the side of the movable frame;

FIG. 8 is an enlarged fragmentary cross sectional view taken substantially along line 8-8 of FIG. 1 and showing the connections between the suction-pressure pan and the sides of the movable frame;

FIG. 9 is an enlarged fragmentary view of the screen mounting and tensioning structure taken substantially in the direction of arrows 9-9 of FIG. 11;

FIG. 10 is a fragmentary enlarged view of the screen mounting and tensioning structure taken substantially in the direction of arrows 10-10 of FIG. 11;

FIG. 11 is an enlarged fragmentary cross sectional view taken substantially along line 11-11 of FIG. 1 and showing the screen tensioning members mounted on the sides of the movable frame of the machine;

FIG. 11A is a fragmentary enlarged view of the screen tensioner;

FIG. 11B is a fragmentary cross sectional view taken crosswise of a vibratory screening machine showing a channel-type structure for mounting vibratory screens on the bed of the movable frame;

FIG. 12 is a fragmentary view taken substantially in the direction of arrows 12-12 of FIG. 11 and showing the manner in which the screen tensioning structure engages the frame of the screen;

FIG. 13 is a fragmentary enlarged side elevational view of the connection between a duckbill valve and the suction-pressure pan which mounts the duckbill valves;

FIG. 14 is an end elevational view of an undulating screen and its sealing relationship with the side of the movable frame;

FIG. 15 is a schematic plan view of the centrifugal blowers connected to the valve arrangements which are connected to the plurality of suction-pressure chambers of the movable frame;

FIG. 16 is a schematic view showing a valve of FIG. 15 in position to provide suction to a suction-pressure chamber;

FIG. 17 is a schematic view showing a valve of FIG. 15 in position to provide pressure to a suction-pressure chamber;

FIG. 18 is a side elevational view of a blower with a slide valve on the suction intake;

FIG. 19 is a schematic view of the slide valve of FIG. 18 in a partially closed position;

FIG. 20 is an exploded view of a four-way valve which is connected between each blower and its associated chamber;

FIG. 21 is a schematic block diagram showing the various operating components associated with the vibratory screening machine;

FIG. 22A is a flow chart showing the main program for operating the vibratory screening machine;

FIG. 22B is a flow chart showing the subroutine for operating the suction aspects relating to the operation of the vibratory screening machine;

FIG. 22C is a flow chart showing the subroutine for operating the ambient aspect relating to th operation of the vibratory screening machine; and

FIG. 22D is a flow chart showing the subroutine for operating the pressure aspect relating to the operation of the vibratory screening machine.

FIG. 23 is a schematic view of a vibratory screening machine, a blower used to create suction, and a system for separating particles and liquid from air before the particles and liquid enter the blower.

FIG. 24 is a section view of an undulating screen.

FIG. 25 is a section view of an undulating screen with coated screen peaks.

FIG. 26 is a section view of an undulating screen with slurry material between the screen peaks.

FIG. 27 is a section view of an undulating screen with coated screen peaks and slurry material between the screen peaks.

FIG. 28 is a section view of an undulating screen.

FIG. 29 is a section view of an undulating screen with a portion of the screen peaks coated.

FIG. 30 is a section view of an undulating screen with a portion of the screen peaks coated.

FIG. 31 is a section view of an undulating screen with a portion of the screen peaks and sides coated.

### DETAILED DESCRIPTION OF THE SPECIFIC EMBODIMENTS

Summarizing briefly in advance, in the operation of the present vibratory screen, screening machine and method, fine particles and liquid are withdrawn from a slurry which contains particles of varying sizes, including fine particles, coarse particles and liquid when chambers underneath the screen bed area are subjected to suction. The withdrawal of the liquid causes the coarse particles which are discharged from the machine to be desirably dry so that they can be disposed of without liquid which was withdrawn. In accordance with one method of the present invention, the chambers are then subjected to pneumatic pressure which aids in forcing the fine particles and liquid out of the chambers and also tends to unclog materials from the screens. In accordance with another method of the present invention, one or more of the chambers are intermittently subjected to suction and release of suction while the machine is operating at a relatively high G force. The suction removes fine particles and liquid from the slurry, and the vibration at the high G force unclogs the screen. The screen assembly includes peaks or ridges and troughs between the ridges. The ridges or peaks include coated portions that close the apertures created by the interwoven wires, thereby sealing the coated regions and enhancing the effect of the applied suction.

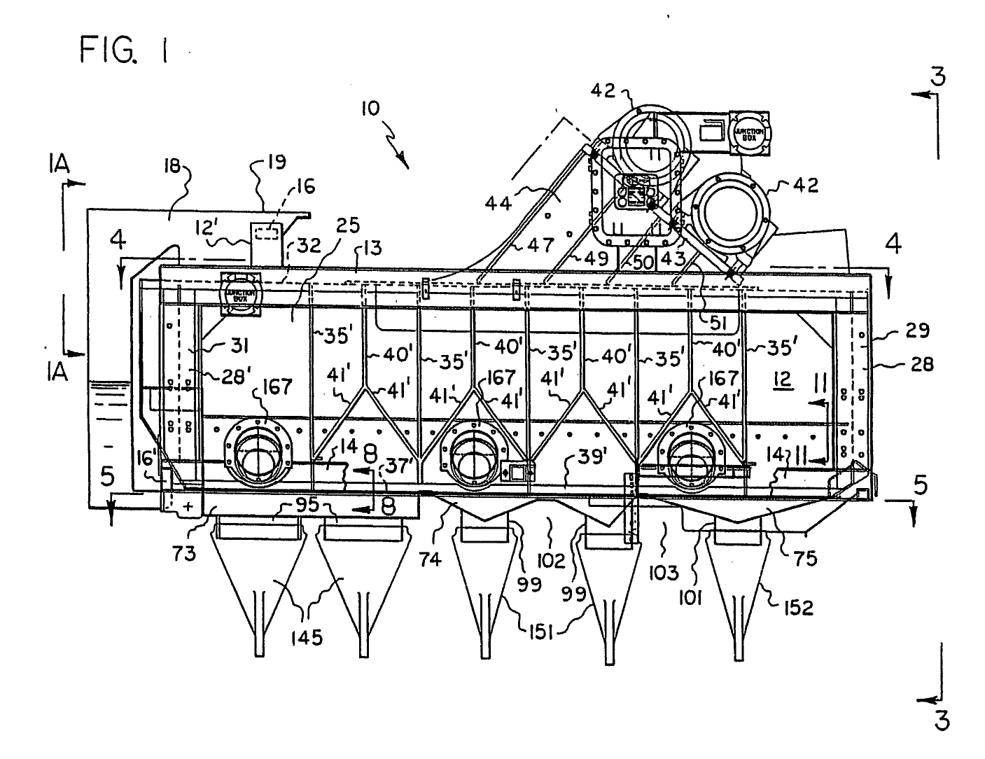

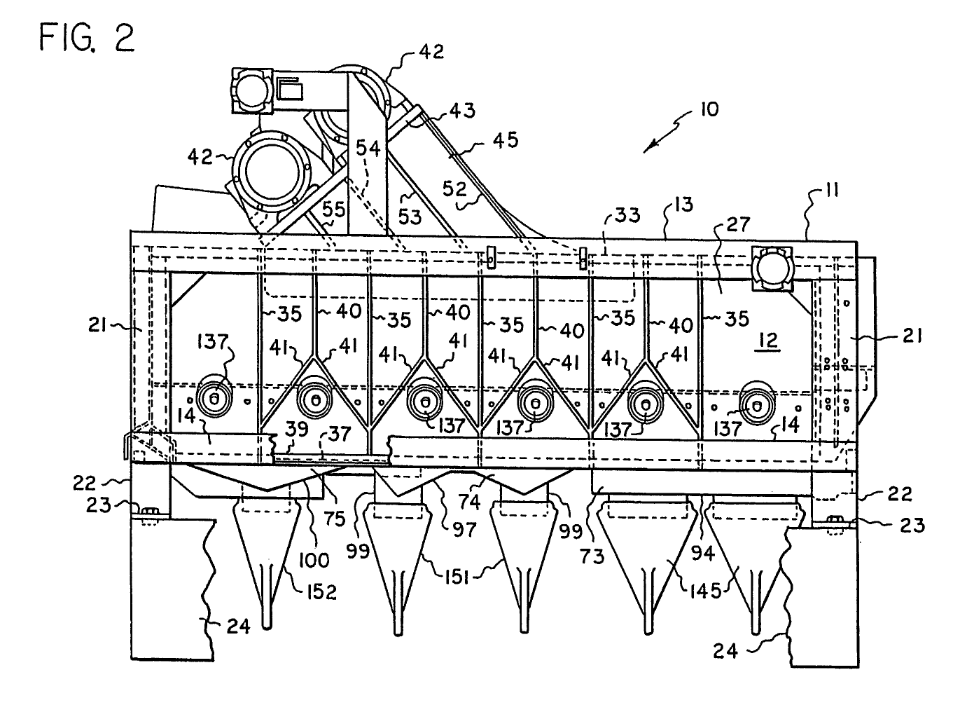

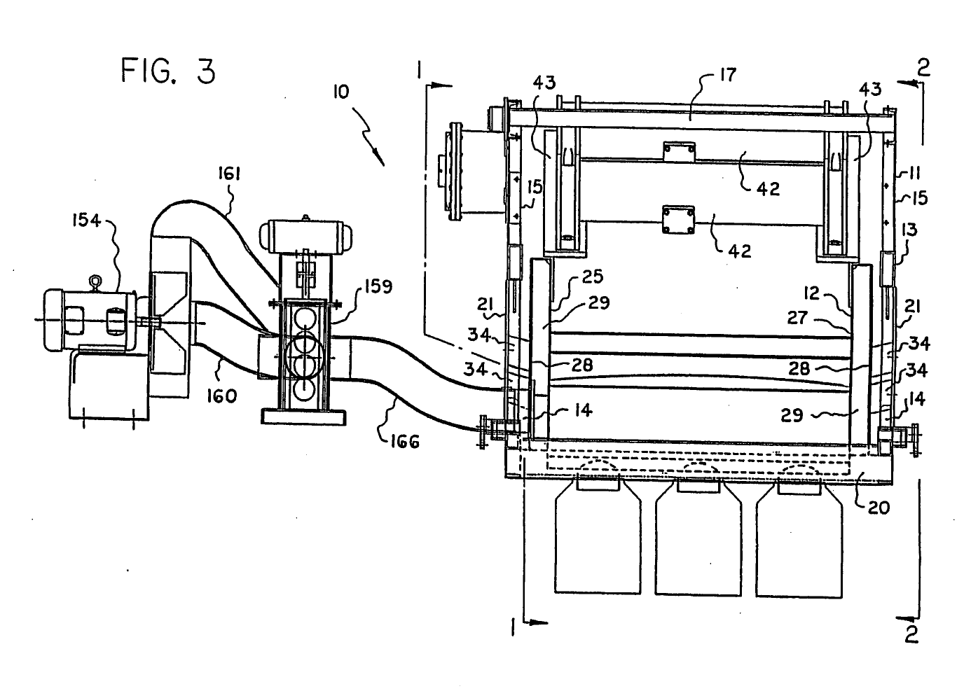

The vibratory screening machine 10 of the present invention includes an outer stationary frame 11 and an inner movable or vibratory frame 12. The outer stationary frame 11 (FIGS. 2 and 3) includes spaced upper elongated tubular members 13 and spaced lower elongated tubular members 14. A pair of post-like members 15 extend upwardly from upper frame members 13 at the outlet end of the machine (FIG. 3) and they are connected by a cross member 17. A slurry feeder 19, shown in FIGS. 1 and 1A extends between the upper frame members 13 and lower frame members 14 at one end of the outer frame 11, and it has its opposite sides connected thereto to support the sides of the frame members 13 and 14 in spaced relationship. In this respect, tubular members 12′ are suitably secured to frame members 13, and bars 16 extend inwardly from tubular members 12′ and are welded to the sides 18 of feeder 19. Frame member 16′ extends between the lower tubular members 14 of the outer stationary frame, and the lower portion of feeder 19 is secured thereto. The feeder does not contact the movable frame 12. The feeder has an elongated opening which extends crosswise to the movable frame 12 to deposit slurry at the slurry inlet end of the machine. The feeder may be mounted in any suitable manner, and is not restricted to the manner shown. The lower frame members 14 are connected to each other by a cross member 20 (FIG. 3) at the opposite lower end of the outer frame 11. The ends of each upper frame member 13 are connected to the ends of a lower frame member 14 by an elongated plate 21 (FIGS. 2 and 3) on each side of the machine. There are channel-like extensions 22 (FIG. 2) extending downwardly from each tubular member 14. Flanges 23 at the bottom of each member 22 mount the stationary frame on a suitable base 24 by means of bolts. The stationary frame 11 of the vibratory screening machine 10 can take any other suitable form for mounting a movable frame inasmuch as the specific form described above is not at all critical, and frames of vibratory screening machines of various forms are well known in the art.

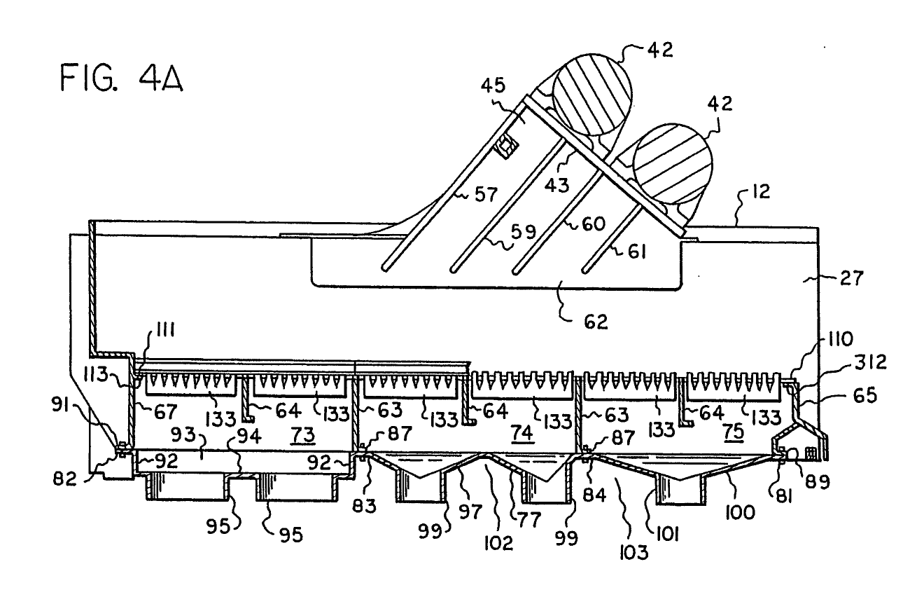

The movable or vibratory frame 12 is resiliently mounted on the stationary frame 11. The movable frame 12 includes two plate-like sides 25 and 27 (FIGS. 1, 2 and 3) which extend for substantially the entire length and height of the movable frame. Channel members 29 (FIGS. 1, 3, 3A and 4) are located at the outlet end 30 of the movable frame 12, and channel members 31 are located at the slurry entry end of movable frame 12. The tops of sides 25 and 27, respectively, are bent over into flanges 32 and 33, respectively (FIGS. 1, 2, 3A, 4 and 8). A pair of resilient mounts 34 (FIGS. 3 and 3A) extend between a leg 28 (FIGS. 3 and 4) of each channel 29 of movable frame 12 and plate 21 of stationary outer frame 11 at each side of the outlet end of the machine (FIGS. 3 and 3A), and a like pair of resilient mounts (not shown) extend between each side 28′ (FIG. 4) of each channel member 31 and each plate 21 at entry portion of the machine to thereby resiliently mount the movable frame 12 on stationary frame 11. There are a total of eight resilient mounts 34 between the stationary and movable frames. The resilient mounts 34 are substantially cylindrical members which have their opposite ends bolted to the members to which they are attached. The resilient mounting structure is well known in the art. It will be appreciated that other types of resilient mounts, such as springs, may be used, as is known.

In FIG. 2A the bracing structure is shown for plate-like side 27 of the movable frame, and, while not described, side 25 of the movable frame possesses substantially identical mirror image bracing structure. In this respect, a series of parallel plate-like ribs 35 are welded to the outside of plate 27 and they extend from upper flange 33 to lower flange 37 (FIGS. 2 and 2A) which is formed at the bottom of plate side 27. An identical flange 37′ (FIGS. 1 and 8) is located at the lower end of side plate 25 of movable frame. Flanges 37 and 37′ are in mirror image relationship (FIG. 8). Flange 37′ terminates at an upturned lip 39′ (FIGS. 1 and 8) and a mirror image lip 39 (FIGS. 2 and 8) is associated with flange 37. Plate-like ribs 40 are welded to side 27 and they extend from upper flange 32 to plate-like ribs 41 which are welded at their lower ends to ribs 35. As can be seen from FIG. 1, side 25 of the movable frame has bracing structure which is the substantial mirror image of the bracing structure described above relative to frame side 27, and the various elements are designated with primed numerals corresponding to the unprimed numerals of frame side 27.

Vibratory motors 42 have their opposite ends securely bolted to bases 43 (FIGS. 1, 2, 4 and 4A) which extend upwardly from sides 25 and 27 of the movable frame. In this respect, side plates 44 and 45 have their bottom edges welded to frame sides 25 and 27, respectively. Ribs 47, 49, 50 and 51 are welded to side plate 44 (FIG. 1), and ribs 52, 53, 54 and 55 are welded to side plate 45 (FIG. 2). The ribs of plates 44 and 45 extend between bases 43 and the top flanges 32 and 33 of frame sides 25 and 27, respectively.

As can be seen from FIG. 4A, plate 45 to which base 43 is attached has internal plate-like ribs 57, 59, 60 and 61, and plate 44 on the opposite side of movable frame 12 has mirror image ribs (not shown). It is also to be noted that plate 45 has a lower portion 62 and this lower portion is welded to the inside surface of movable frame side 27. Mirror image structure (not shown) is associated with motor-supporting plate 44.

At this point it is to be noted that the general structure of the outer frame 11 and the inner frame 12 thus far described are exemplary of well-known prior outer and inner frames of vibratory screening machines. However, it will be appreciated that other inner and outer frame structures can be utilized provided that they incorporate modifications which are required to produce the suction-pressure aspects of the present invention.

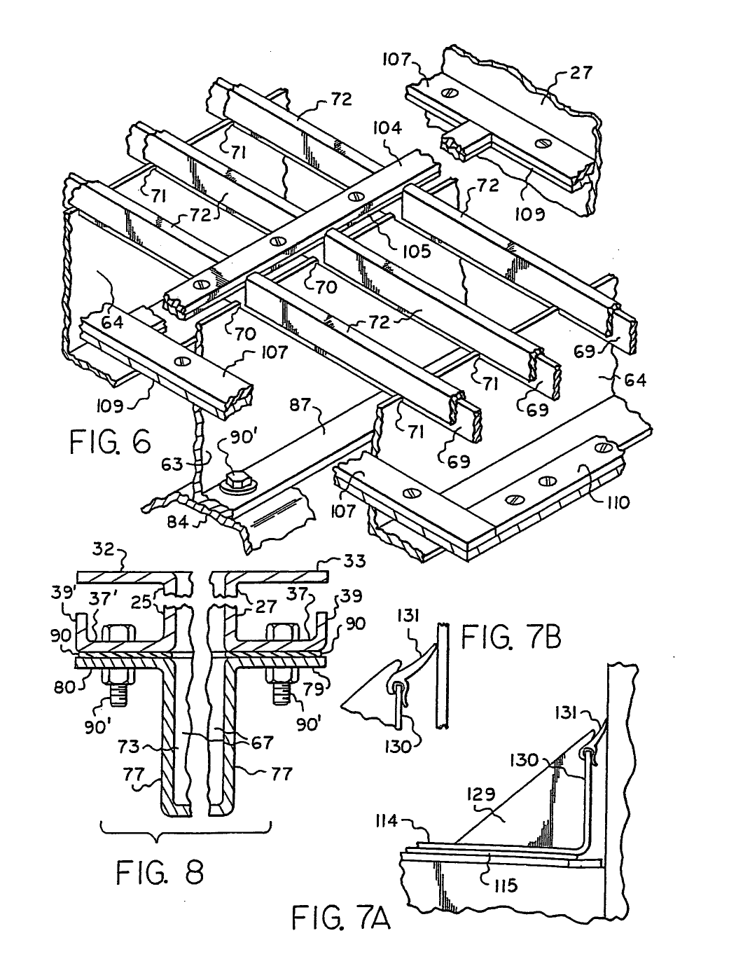

In accordance with the present invention, the movable frame 12 has been structured so as to contain a plurality of suction-pressure chambers 73, 74 and 75 underneath the screen bed so that the screens thereon can be alternately subjected to suction to thereby draw liquid and fine particles from a slurry being screened and thereafter be subjected to pneumatic pressure for the dual purpose of both (1) aiding in emptying the suction-pressure chambers of the liquid and fine particles which pass through the screens and (2) also blowing out material which clogs the screens. In the foregoing respect, the opposite ends of major ribs 63 (FIGS. 4, 4A and 6) are welded to frame sides 25 and 27. Minor ribs 64 also have their opposite ends welded to frame sides 25 and 27. A plate 65 (FIGS. 4 and 4A) has its opposite ends welded to frame sides 25 and 27 at the outlet end of the screen bed. A plate 67 (FIGS. 4 and 4A) has its opposite ends welded to plates 25 and 27 at the slurry entry end of the screen bed. Stringers 69 extend lengthwise at equally spaced intervals between plates 65 and 67 and they are received in notched portions 70 of major ribs 63 and slots 71 of minor ribs 64. Channel-shaped plastic caps 72 are mounted on stringers 69, as is known in the art.

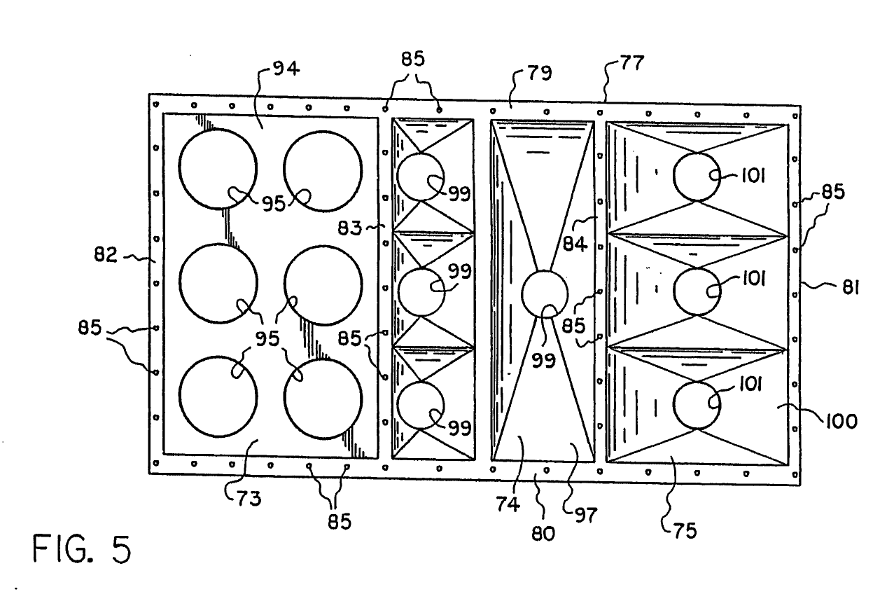

The three suction-pressure chambers 73, 74 and 75 (FIGS. 1, 2 and 4A) are produced by bolting a pan 77 (FIGS. 4A and 5) to the ribs 63 and frame sides 25 and 27 and plates 65 and 67 of movable frame 12. Pan 77 includes flange edge portions 79, 80, 81 and 82 which lie in a single plane. They also include central strip-like portions 83 and 84 which also lie in the same plane. Spaced perforations 85 (FIG. 5) are provided in the foregoing flange members 79, 80, 81 and 82 and in central strip-like portions 83 and 84. The central strip portions 83 and 84, which lie in the same plane with the flange members, are bolted to flanges 87 of major ribs 63 by bolts such as 90′. The flange 80 of pan 77 (FIG. 8) is bolted to flange 37′ of frame side 25 by a plurality of bolts 90′ which extend through the perforations 85. Flange 79 of pan 77 is bolted to flange 37 of frame side 27 by bolts 90′ also. The flange edge 81 of pan 77 is bolted to flange 89 of plate 65 (FIG. 4A), and flange 82 of pan 77 is bolted to flange 91 of plate 67. Suitable gaskets or sealants 90 (FIG. 8) are provided between all of the flanges 79, 80, 81 and 82 of the pan 77 and the flanges 37′ and 37 of side walls 25 and 27, respectively, and the flanges 89 and 91 of plates 65 and 67, respectively. Also, suitable gaskets or sealants are provided between central strips 83 and 84 of pan 77 and flanges 87 of ribs 63 to thereby provide fluid-tight connections between pan 71 and side walls 25 and 27 and ribs 63 and plates 65 and 67.

As can be visualized from FIG. 4A, chamber 73 is bounded by the lower portions of side walls 25 and 27 and rib 63 and plate 67. Chamber 74 is bounded by the lower portions of side plates 25 and 27 and spaced ribs 63. Chamber 75 is bounded by the lower portions of side plates 25 and 27 and rib 63 and plate 65. Also chamber 73 is bounded by the four sides 92 and 93 of pan 77 and the bottom portion 94 of pan 77 which has ducts 95 extending downwardly therefrom. Chamber 74 is also bounded by formed bottom wall 97 which has ducts 99 extending downwardly therefrom. Chamber 75 is also bounded by bottom wall 100 which has ducts 101 extending downwardly therefrom. Thus, the chambers 73, 74 and 75 are sealed from each other by the above-described structure. At this point it is to be noted that the reason bottom walls 97 and 100 of pan 77 are shaped as they are is to allow spaces 102 and 103 (FIGS. 1 and 4A) between the sides 25 and 27 of the movable frame, for other structure of the vibratory screening machine, namely, shafts (not shown) connected to the stationary frame 11 which have to extend through those spaces and which are used for tilting the movable frame 12. However, since these portions of the vibratory screening machine are totally unrelated to the subject matter of the present invention, they are not shown. It will be appreciated that the pan can take any desired shape consistent with the structure of the machine, and it is not restricted to the shape shown.

The bed of the movable frame includes the following structure. Laid crosswise to the stringers 69 are plastic strips 104 (FIGS. 4 and 6) which are suitably bolted to strips 105 welded to stringers 69 (FIG. 6). Plastic strips 107 (FIGS. 4 and 6) are bolted to flanges 109 (FIG. 6) which are welded to side plates 27 and 25, respectively, of the movable frame. Also, plastic strips 110 and 111 (FIGS. 4, 4A and 6) are bolted to flanges 312 and 113 of plates 65 and 67 (FIG. 4A), respectively. Plastic strips 107 extend for substantially the entire length of the screen bed between plastic strips 110 and 111. Plastic strips 104, 110 and 111 extend for substantially the entire width of the screen bed between plastic strips 107. The upper surfaces of plastic strips 104, 110 and 117 are curved downwardly, and these strips along with strips 107 lie in the same arc. The above-described plastic strips 104, 107, 110 and 111 constitute the portion of the screen bed to which screens are placed in sealing relationship. The additional portions of the screen bed which engage the screens in supporting relationship are the plastic caps 72.

In the embodiment shown in FIG. 4, a plurality of screening screens is mounted on the screen bed and the edges on their undersides are positioned in substantially sealing relationship with plastic strips 107, 104, 110 and 111. More specifically, there are two undulating screens 112 (FIGS. 4, 4C and 14) positioned in sealing relationship with the bed of the movable frame above chambers 73 and 74. In this respect, one undulating screen is located above chamber 73 and it has its edges in sealing engagement with strips 104, 107 and 111. The central undulating screen is located above chamber 74 and it has its edges in sealing engagement with strips 104 and 107. A planar screen 113 (FIGS. 4 and 4B) is positioned over chamber 75 with its edges in sealing relationship with strips 107, 104 and 110 at the discharge end of the screen bed. In the foregoing respects, as can be noted from FIGS. 4 and 4D the screens of undulating screens 112 are mounted on perforated plates 114. The planar screen is also mounted on a perforated plate 114. A perforated plate of this type is fragmentarily shown in FIG. 4D. Its underside has a resilient flexible plastic bead 115 on its entire periphery. Therefore, the plastic bead 115 of plate 114 of the planar screen 113 provides sealing contact with plastic strips 107, 104 and 110. The plastic strip 115 on perforated plate 114 of the central undulating screen 112 provides sealing engagement with portions of plastic strip 107 and plastic strips 104. The edges of perforated plate 114 of undulating screen 112 provide sealing engagement with plastic strips 107, 104 and 111. While the above description has referred to two undulating screens and one planar screen, it will be appreciated that there can be any desired mix of the foregoing screens or the screens can be all undulating or all planar. It will be appreciated that other types of seals can be used instead of seal 115, including but not limited to gaskets between plate 114 and the bed of the machine. Further, although the screen assemblies 112,113 have been described as mounted on perforated plate 114, other support structures can be employed for supporting the screens.

Insofar as pertinent here, the undulating screens 112 have one or more layers of undulating screening material 117 with their troughs 332 (FIG. 4C) bonded to the perforated plate 114. Undulating screens of this type are known in the art, and are shown in U.S. Pat. No. 6,220,048 (Screen assembly for vibratory screening machine); U.S. Pat. No. 6,161,700 (Vibratory screening screen and method of fabrication thereof); U.S. Pat. No. 6,153,041 (Screen assembly for vibratory screening machine and method of fabrication thereof); U.S. Pat. No. 6,053,332 (Method of fabricating undulating screen for vibratory screening machine); U.S. Pat. No. 6,000,556 (Screen assembly for vibratory screening machine and method of fabrication thereof); U.S. Pat. No. 5,958,236 (Undulating screen for vibratory screening machine and method of fabrication thereof); U.S. Pat. No. 5,944,993 (Screen assembly for vibratory screening machine and method of fabrication thereof); U.S. Pat. No. 5,888,336 (Screen assembly for vibratory screening machine and method of fabrication thereof); U.S. Pat. No. 5,876,552 (Method of fabricating undulating screen for vibratory screening machine); U.S. Pat. No. 5,868,929 (Screen assembly for vibratory screening machine); U.S. Pat. No. 5,783,077 (Undulating screen for vibratory screening machine); U.S. Pat. No. 5,720,881 (Screen assembly for vibrating screening machine); U.S. Pat. No. 5,636,749 (Undulating screen for vibratory screening machine); U.S. Pat. No. 5,417,859 (Undulating screen for vibratory screening machine and method of fabrication thereof); U.S. Pat. No. 5,417,858 (Screen assembly for vibrating screening machine); U.S. Pat. No. 5,417,793 (Undulating screen for vibratory screening machine and method of fabrication thereof); all of which may be referred to for relevant information and are incorporated herein by reference. Planar screen 113 has a plurality of flat layers of screen material 120 bonded to a perforated plate 114. A screen of this type is known in the art and shown in U.S. Pat. No. 4,575,421 which may be referred to for relevant information and is incorporated herein by reference. The undulating screens 112 are placed in end-to-end relationship and the planar screen 113 is placed in abutting relationship with an edge of the central undulating screen 112.

The perforated plate 114 of the undulating screens 112 is bent up at 121 (FIG. 4C). A filler of epoxy 122 is located between the bent-up edge 123 of the screening material 117 and the flange 121, both of which extend for the entire width of the screen. A flexible plastic wiper 124 is mounted as shown in FIGS. 4C and 14 wherein a slotted portion 126 thereof straddles the upper edge of flange 121 and a side of slotted portion 126 is embedded in the epoxy. The wiper 124 thus makes a sealing engagement between the entire side of the screen and the frame wall 25. The wiper 124 deters slurry from bypassing the screen and also effectively acts as a supplemental seal between the screen and the bed of the machine along the side wall of the machine. An analogous wiper support construction is provided in mirror image relationship on the opposite side of the screen and seals that side of the screen to the opposite wall 27 of the frame.

The planar screen 113 (FIG. 4B) has shell 125 of epoxy overlying foam material for the entire width of the screen, and the shell 125 includes a blocked off end at 129 and at the opposite end of shell 125 to provide fluid-tight connections between plate 114, flange 130 of plate 114 and shell 125. A flexible plastic wiper 131 is mounted on the upper edge of flange 130 and is bonded to the edge 132 of epoxy 125 and the upper edge of flange 130. The wiper 131 deters slurry from bypassing the screen and also effectively acts as a supplemental seal between the screen and the bed of the machine along the side wall of the machine. An analogous wiper support construction is provided in mirror image relationship on the opposite side of the screen, as can be visualized from FIG. 11. Thus, the wipers, such as 131, on the edges of planar screen 113 will provide sealing engagement with the side walls 25 and 27 of the movable frame for the entire width of the screen.

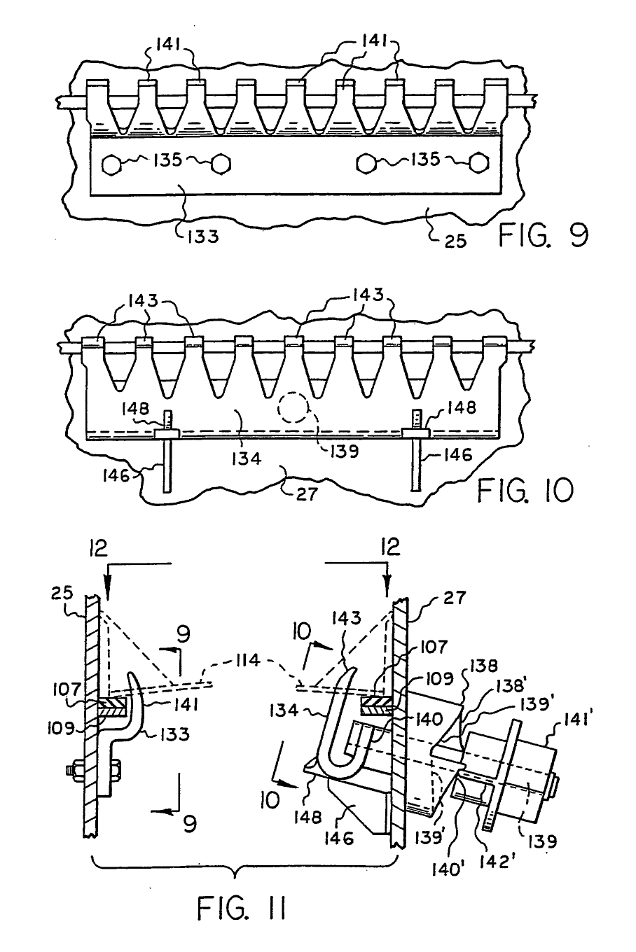

In the present instance, both the undulating screens 112 and the planar screen 113 are mounted on the screen bed by toothed tensioning members 133 and 134 on side walls 25 and 27, respectively (FIGS. 9, 10 and 11). In this respect, the toothed tensioning members 133 (FIGS. 4A, 9 and 11) are bolted to side wall 25 by bolts 135. A plurality of toothed tensioning members 134, equal in number to tensioning members 133, are movably mounted toward and away from side wall 27 by means of cam-operated tensioners 137 (FIG. 2) mounted on side wall 27. In FIGS. 11 and 11A the tensioner 137 is shown in more detail. It is mounted on frame side 27, and it includes a cam base 138 fixedly secured to frame side 27. The cam base 138 has two cam tracks 138′, each of which has a low point 139′ spaced 180 degrees apart, each gradually leading to two high points 140′ spaced 180 degrees apart. A cam follower nut 141′ (FIG. 11) is rotatably secured to the end of shaft 139 of toothed member 134. Cam follower nut 141′ has two cam follower legs 142′ (only one shown) spaced 180 degrees apart. When the cam follower legs 142′ are on the two low points 139′, shaft 139 extends inwardly from side 27 more than when the cam follower legs 142′ are rotated with nut 141′ to the high points 140′. When the cam follower nut is rotated to move cam follower legs 142′ to high points 140′, shaft 139 will be caused to move to the right in FIG. 11 to pull toothed tensioning member 134 to the right to tension the screen mounted between toothed members 133 and 134. When it is desired to loosen a screen to remove it from the machine, the nut 141′ is rotated in the opposite direction to cause the cam follower legs 142′ to return to the low points 139′ of cam 138′. A cylindrical housing 146, shown only in FIG. 11A, surrounds the structure shown in FIG. 11 to shield it from extraneous matter. As noted in FIG. 4A, there are two toothed tensioning members 133 associated with each screen. There are a like number of toothed tensioning members 134 also associated with each screen. Toothed tensioner members and cam-operated tensioners are known in the art.

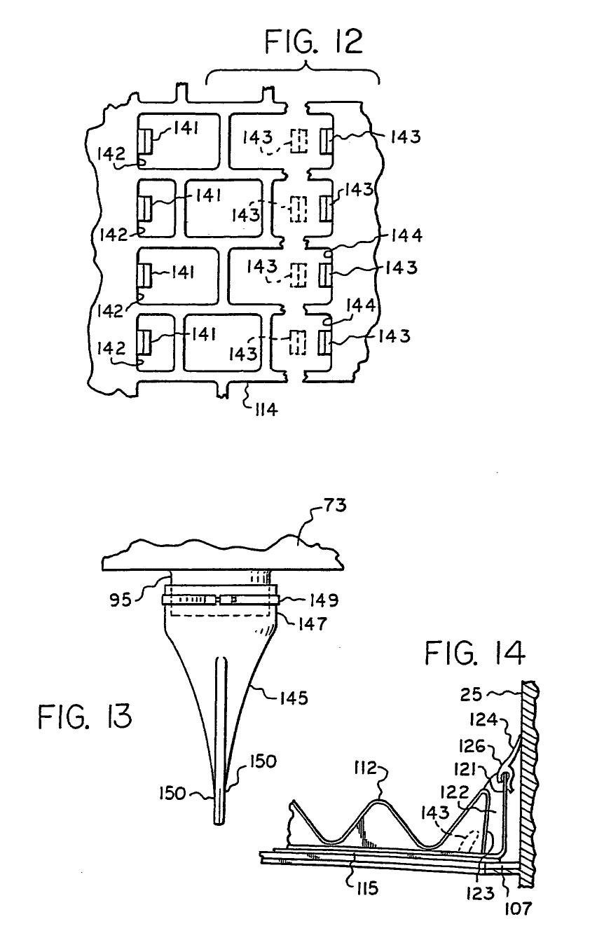

Each perforated plate 114 is mounted in the following manner. Each perforated plate 114 (FIG. 12) is mounted on teeth 141 of two adjacent fixed toothed tensioning members 133 such that the teeth 141 enter the perforations closest to the edge of the plate. The teeth 143 of two adjacent movable members 134 are inserted in the perforations such as 144 of the perforated plate 114 at the opposite side of the plate from perforations 142. In the undulating screens 112 (FIG. 4C) the teeth 143 enter the perforations 144 to the left of the bent-up edge 123 (FIG. 14), and the teeth 141 enter the perforations 142 in the opposite edge of the screen in an analogous manner. In the planar screens 113 (FIG. 4B) the teeth 143 enter the foam material within epoxy shell 125 and displace it. The teeth 141 enter the foam material on the opposite side of the plate 114 and displace it. Thereafter, the teeth 143 are moved to their solid line position of FIG. 12 from their dotted line position by the operation of tensioners 137, to thereby tension the screen and cause the teeth 141 of fixed toothed member 133 to engage the edges 142 of the perforations on which they are located. When the toothed tensioning members 134 move toward and away from frame side 27, they are supported by plates 146 (FIGS. 10 and 11) welded to frame side 27. The undersides of inverted T-shaped members 148 on each toothed tensioning member 134 slide on the top surfaces of plates 146. When all the screens are fully tensioned, the sealing strips 115 on the underside of the screens will engage the adjacent plastic strips such as 104, 107, 110 and 111 on the screen bed and also cause the wipers 124 and 131 on the opposite edges of the screens to engage the side walls 25 and 27 of the movable frame.

In FIG. 11B another well-known screen construction and tensioner arrangement is shown. In such an arrangement a screen 136 includes a screen 135′ mounted on a plate 137′. Plate 137′ includes apertures therein, and the edges of the plate are bent up into channels 138′. The sides 25 and 27 have plates 139′ secured thereto, and bolts 140′ extend therethrough and through channel members which engage screen channels 138′ and tension the screen when the bolts are tightened. The tensioning also causes-the central portions of the screen to bear on stringers 141′ and the edges of the plate 137′ to rest on plastic strips 107 which are bolted to flanges 109. It will be appreciated that other tensioning structures can also be used including but not limited to pretensioned screen arrangements.

A plurality of duckbill valves 145 (FIGS. 1, 2 and 13) have upper cylindrical openings 147 which are mounted on cylindrical ducts 95 associated with chamber 73. The mounting is effected by means of ring clamps 149. As is well understood in the art, duckbill valves 145 are fabricated from resilient material such as rubber or resilient plastic and they have spaced lips 150 at their lower edges which will remain closed when the valve is subjected to suction but will be forced open when they are subjected to pneumatic pressure. A plurality of duckbill valves 151 are mounted on ducts 99 of chamber 74. A plurality of duckbill valves 152 are mounted on ducts 101 of chamber 75.

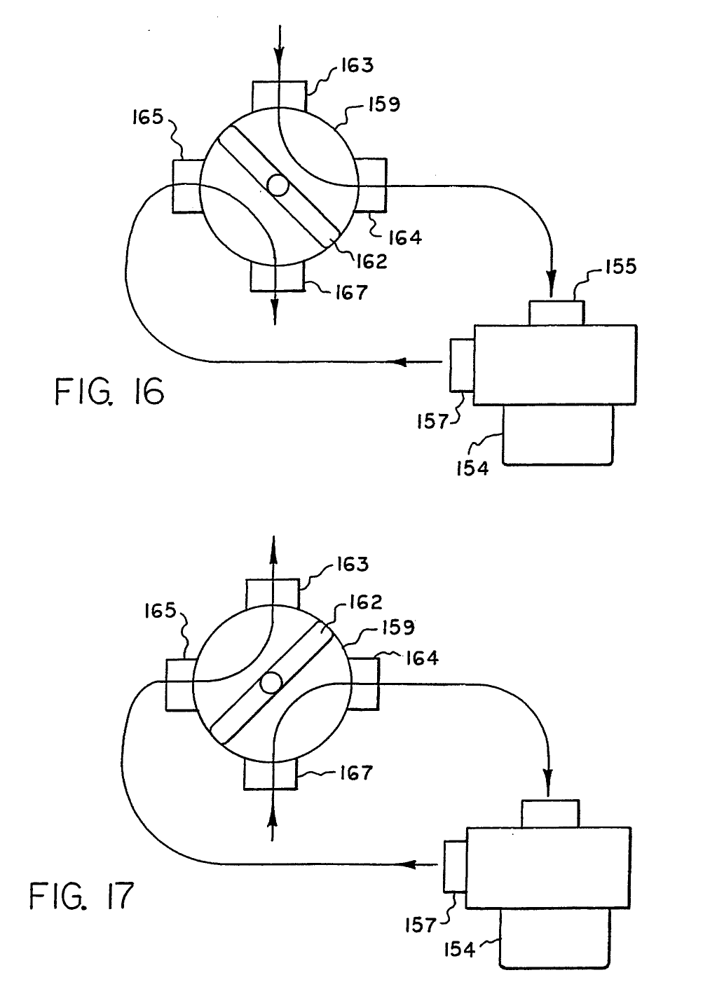

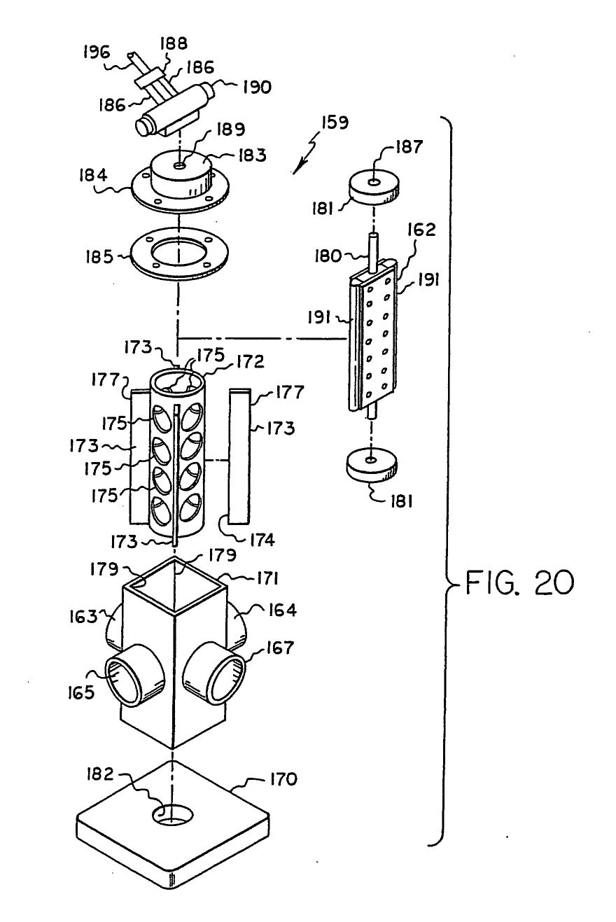

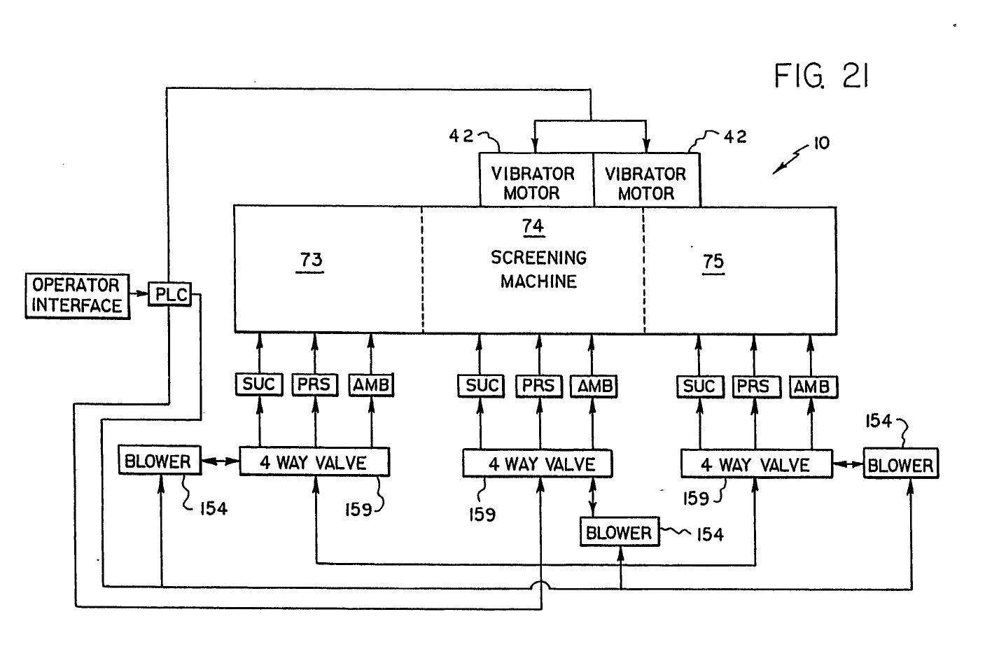

Structure is provided for supplying each of chambers 73, 74 and 75 alternately with suction and pressure (FIGS. 1, 3, 15, 16 and 17). In this respect, a plurality of centrifugal blowers 154 is provided having suction inlets 155 and pressure outlets 157. A four-way valve 159 is connected to each blower 154. In this respect each blower has a conduit 160 which connects the four-way valve 159 to suction conduit 155 of the blower, and a conduit 161 connects the blower pressure outlet 157 to the four-way valve. When the vane 162 of a four-way valve 159 is in the position shown in FIG. 16, the chamber such as 73, 74 and 75 will be subjected to suction because the air flow will be from the suction-pressure chamber through duct 166 leading from the chamber, duct 163 of the four-way valve, the four-way valve, duct 164 of the four-way valve and into suction inlet 155 of the blower 154. The suction will cause fine particulate material and liquid to be withdrawn from the slurry and deposited in chambers 73, 74 and 75 while the coarse material will not pass through the screens and it will be dried. At the same time the pressure duct 157 will be in communication with the four-way valve 159 through conduit 161 which is mounted on duct 165, and the pressure produced by blower 154 will be discharged from duct 167 of the four-way valve. When a chamber 73, 74 or 75 is subjected to pressure, the four-way valve 159 has its vane 162 in the position shown in FIG. 17 so that pressure will be supplied from blower duct 157 to conduit 161 and duct 165, through valve 159 and into duct 166 leading to the chamber. When the valve 159 is in the position of FIG. 17, air will be supplied to the blower through duct 167 of valve 159, through valve 159, through conduit 160 and suction inlet 155. The providing of pneumatic pressure to chambers 73, 74 and 75 will aid in forcing the fine material and liquid out of the chambers through the duckbill valves. Also, the pneumatic pressure will tend to unclog the screens.

In the operation of the machine 10 under conditions of suction and pressure, the maximum suction was at six inches of water and the maximum pressure was at six inches of water. However, it will be appreciated that the suction and pressure may vary depending on the nature of the slurry which is being screened. Also, while three chambers have been shown as being capable of having suction and pressure applied to all of them simultaneously, it will be appreciated that only one or two of the chambers may have the suction and pressure applied thereto depending on the nature of the slurry. Screens of 175 mesh have been used in tests. However, the screens may range between about 38 and 325 mesh depending on the nature of the slurry.

In FIGS. 18 and 19 a slide valve 192 is shown mounted on blower 154. The plate 192 fits slidably between a pair of plates 193 and 194 which are mounted on suction inlet 155. As can be seen in FIG. 18 the slide valve is in a fully opened position and in FIG. 19 the slide valve is in a partially closed position. By this arrangement the amount of air flowing through each blower 154 and each chamber 73, 74 or 75 can be varied as may be desired for different installations.

In FIG. 1 the rims 167 are shown to which conduits 166 are connected. It will be appreciated that the conduits can be connected in any suitable manner. The rims 167 are perforated, and mating perforated plates at the ends of conduits 166 are bolted to plates 167. It will be appreciated that the various conduits may be connected to the various ducts in any suitable manner, including but not limited to ring clamps of the type shown in FIG. 13.

In FIG. 20 an exploded view of a preferred four-way valve 159 is shown. The valve includes a substantially square base 170 on which the lower end of housing 171 of substantially square cross section is mounted. Four cylindrical ducts 163, 164, 165 and 167 extend outwardly from housing 171. A perforated cylinder 172 is mounted within housing 171 and it has four strip-like divider members 173 having their inner edges 174 bonded, as by welding, to cylinder 172. Each divider 173 is located between two adjacent series of four circular openings 175. In this respect there are four vertical rows of openings 175 with each row containing four circular openings which communicate with the inside of cylinder 172. In its assembled position, the outer edges 177 of dividers 173 are in sealing engagement with the corners 179 of housing 171. The centers of each vertical row of apertures 175 are spaced 90 degrees apart, and the dividers 173 are also spaced 90 degrees apart. The dividers 173 are spaced 45 degrees from the centers of the apertures 175. The vane 162 is mounted on a shaft 180, the opposite ends of which are rotatably mounted in caps 181. The lower cap 181 is received in bore 182 in base 170. The upper cap 181 is received in cylindrical portion 183 of cap 184 which is mounted on housing 171 through ring 185 which is mounted on the upper end of housing 171. The shaft 180 extends through bore 187 in cap 181 and also extends through bore 189 in cap 183 and is received in double acting pneumatic actuator 190 which has internal mechanism to pivot shaft 180 to move vane 162 back and forth an amount of 90 degrees to cause vane 162 to move between the positions shown in FIGS. 16 and 17. Actuator 190 has two conduits 186 coupled thereto which in turn are coupled to a solenoid valve 188 which controls the flow of compressed air from conduit 196 to conduits 186, as discussed in detail hereafter. Alternately, shaft 180 can be pivoted manually by forming its top into a non-circular shape and applying a handle or wrench thereto, thereby eliminating the need for an actuator 190. Vane 162 has suitable wipers 191 on opposite edges thereof which gauge the inside of cylinder 172 in fluid-tight relationship. As can be visualized from FIGS. 16 and 17 in each of the two positions of vane 162, it causes communication between two adjacent vertical series of apertures 175 of cylinder 172.

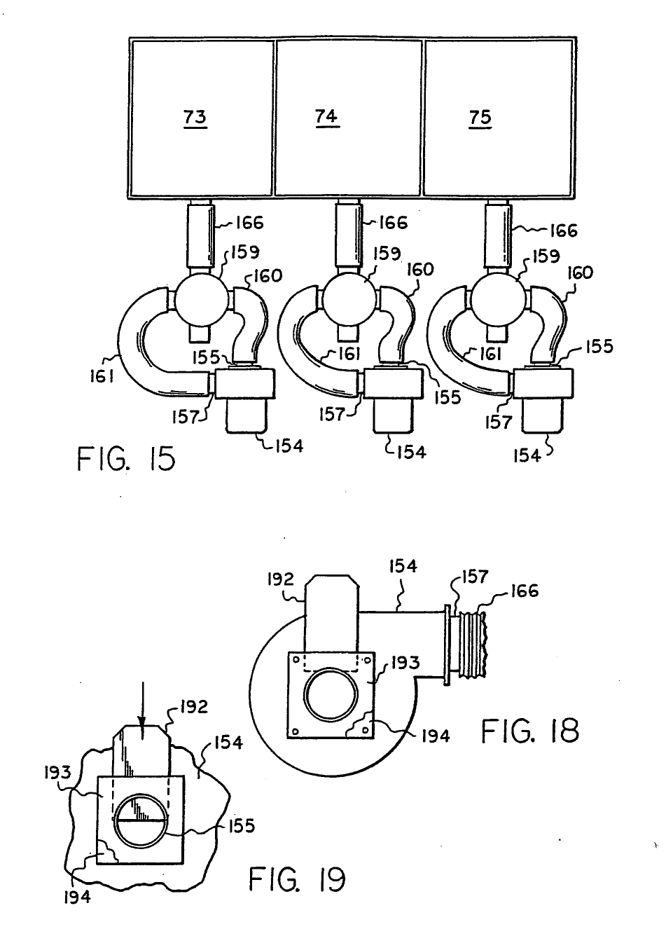

The valve 159 has been designed so that the total area of four apertures in a vertical row equals the total cross sectional area of a conduit, such as 165 or 167. In addition, the volume between a pair of dividers 173 and the outside of cylinder 172 and the side of housing 171 between adjacent dividers 173 has a volume which is at least as great as the volume which will not throttle the air passing through the valve between two adjacent ducts such as 165 and 167. The foregoing parameters will permit the necessary air flow through the valve 159 without unnecessarily throttling it. As noted above, the reason for the vertical cylinder 172 with the four sets vertical apertures therein, is so that the footprint of base 170 occupies a relatively small area so as to be extremely well adaptable for use on offshore drilling rigs where floor space is at a premium. However, it will be appreciated that in areas where floor space is not at a premium, any suitable four-way valve which functions in the manner described above relative to FIGS. 15-17 can be used.

In accordance with another method of the present invention, a slurry containing a mixture of fine and coarse particles of varying sizes and liquid can be screened by alternating the application of periods of suction and release of suction to the one or more chambers. The foregoing has been effected by the use of a blower 154 with a valve such as 159 by merely disconnecting conduit 161 from valve duct 165 so that the latter is open to the atmosphere. It is believed that the release of suction causes the chamber to return to full atmospheric pressure because the chamber is open to the atmosphere through the valve 159 and duct 165 and also through the screen. However, it is possible that some residual suction may have remained in the chamber if the period of release of suction has been very small. If only one chamber is to be subjected to suction, it is preferably the chamber at the exit end of the machine, namely, chamber 75. In a test, the suction which has been applied to a single chamber at the exit end of the machine has been up to ten inches of water, and it has generally been about six inches of water. The foregoing was effected with a 175 mesh screen, although, as stated above, the screen mesh can be anywhere between about 38 and 325 mesh, depending on the nature of the slurry which is being screened. In the test, the suction was applied for periods of four seconds and there were intermittent releases of suction for periods of one second. It is believed that the suction was completely released during the period of one second, but it may have been reduced to a lesser value, considering the short release period. In tests, both the flat screen and an undulating screen were used at the exit end of the machine above chamber 75. It was observed that the undulating screen performed better because it channeled the material lengthwise in rows whereas the flat screen permitted the material to drift slightly to the sides of the machine. The screens were vibrated at approximately 6½ G's, and it was observed that this relatively high vibratory force kept the screen above chamber 75 very clean. However, it is believed that the G force can be between about 3 to 12 G's depending on the capability of the screens to withstand the higher G forces. However, preferably the G force could be between 5 to 9 G's and most preferably between 6 to 8 G's. Generally the G force should be in excess of 6 G's for good anticlogging operation of the screens.

The periods of suction and the release of suction can be effected by the use of a programmable logic controller (PLC) which controls the shifting of the valve 159. In the operation of the vibratory screening machine under suction and release of suction conditions only, as described above, the weight of the liquid and fine particles which were pulled into the chamber opened the duckbill valves to release the liquid and fines therefrom when the liquid and fines reached a predetermined depth above the valves. It is possible to use a different system for applying suction to a chamber, namely, by intermittently applying a greater suction and a lesser suction by intermittently venting the chamber to produce periods of lesser suction.

In FIG. 21 a block diagram is shown which illustrates the operation of the entire system. At the operator interface the operator enters the mode of operation of the system, preferably by means of a key pad or mouse. Broadly, the system permits the operation of all the chambers 73, 74 and 75 by suction and pressure, or permits the operation of all of the chambers by suction and ambient or only under ambient conditions when the blowers 154 are not in operation. Also with suitable expansion of the PLC, the system will permit each chamber of the group to be operated independently of the others either by suction and pressure, or by suction and ambient, or only by ambient. Also, the time of application of the periods of suction, ambient or pressure may be varied for each chamber.

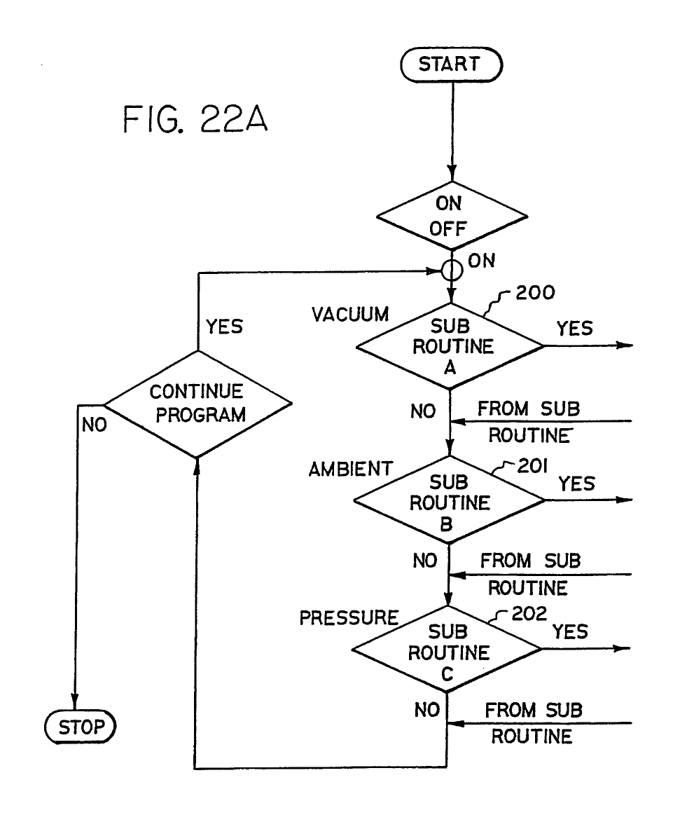

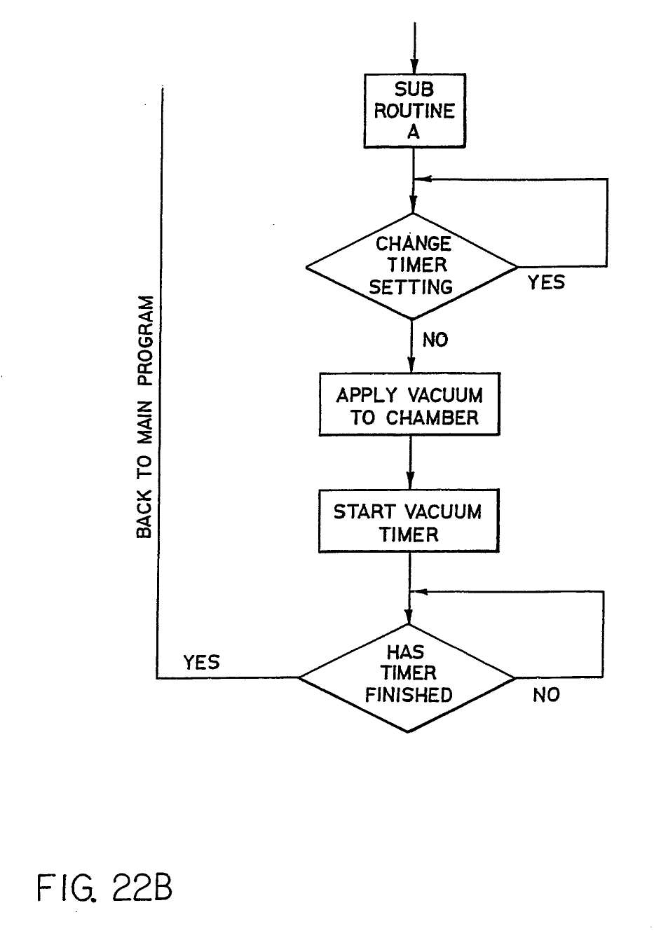

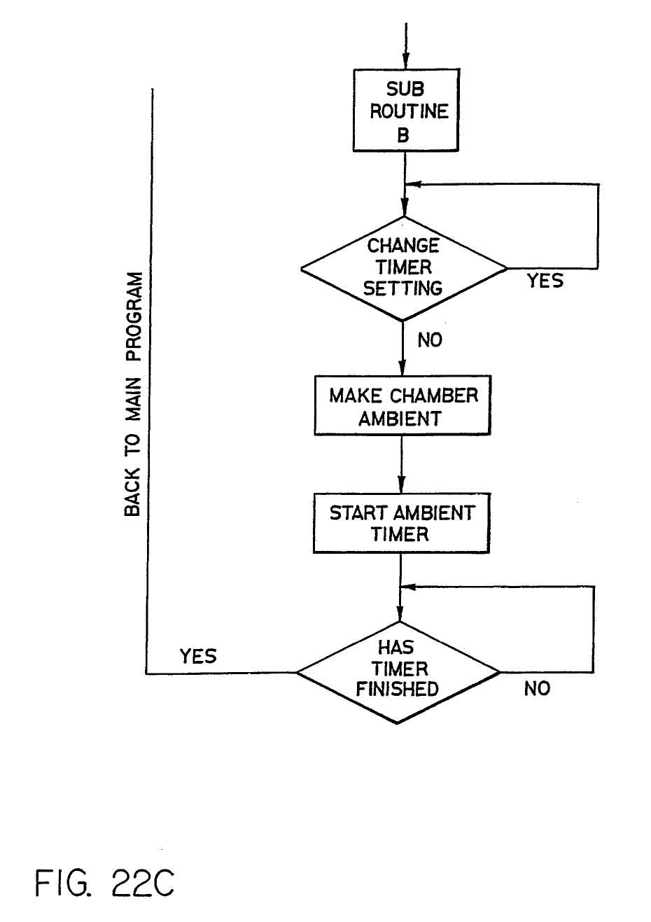

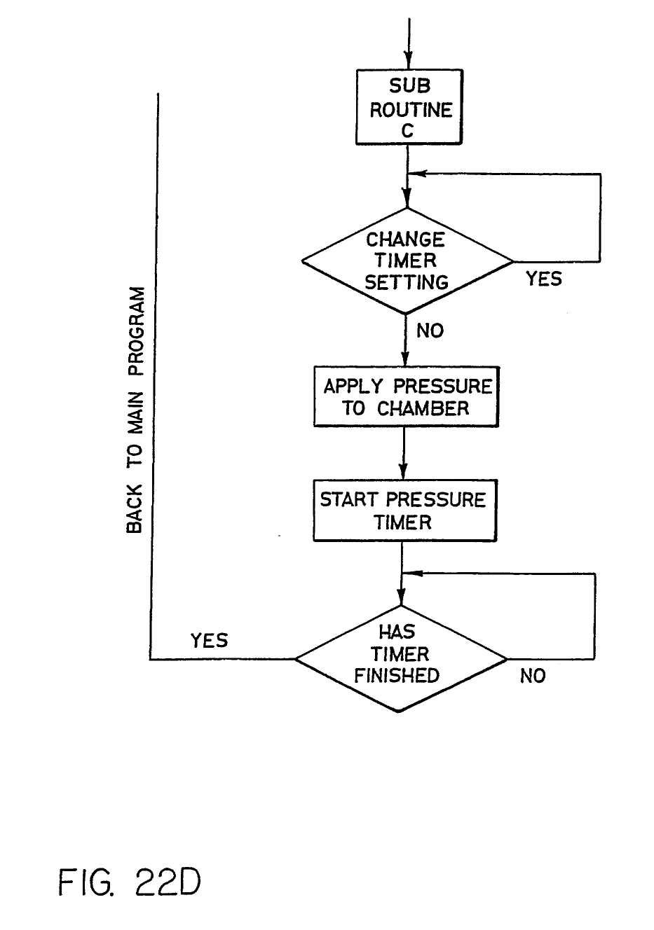

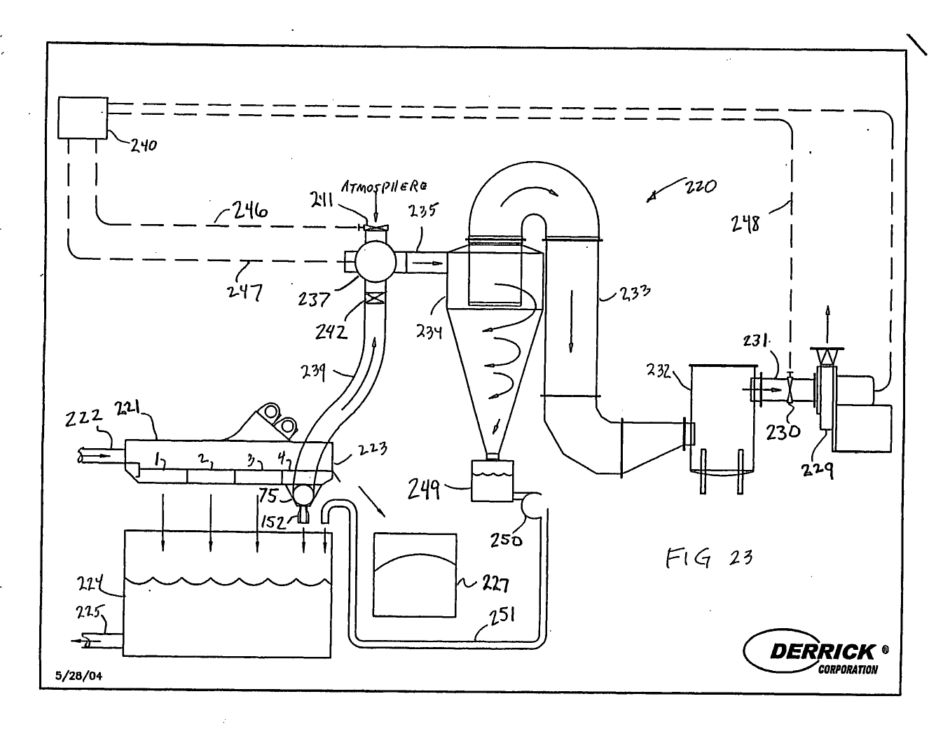

As the system is shown in FIG. 21, the mode of operation will apply identically to each of the three chambers 73, 74 and 75. When the system is to operate by suction and pressure, the system is set up as shown in FIG. 15 wherein all conduits 161 are connected between the blowers 154 and the four-way valves 159 as shown. The main program (FIG. 22A) is started, and this energizes the decision blocks 200, 201 and 202 for the three subroutines A, B and C, respectively. Subroutines A, B and C are dependent on the input of the operator. Subroutine A relates to the application of suction to the chambers; subroutine B relates to the application of ambient to the chambers; and subroutine C relates to the application of pressure to the chambers.

When the system is to operate with simultaneous alternate applications of suction and pressure to all of the chambers, the following procedure is followed. Subroutine A (FIG. 22B) is executed in the following manner. Timer setting for the period of suction is determined in the “Change Timer Setting” block. After it is set, the PLC sends out a signal to cause the suction to be applied to each chamber upon the start of the suction timer. In this respect, the signal is applied to each solenoid valve 188 associated with each valve 159. The signal causes each solenoid valve 188 to cause flow of compressed air from conduit 196 to the proper conduit 186 to shift the double acting pneumatic actuator 190 to shift its associated valve 159 to apply suction to each chamber 73, 74 and 75. After the timer has finished in accordance with the timer setting, the subroutine A will return back to the main program. After the return of subroutine A to the main program, the subroutine B (FIG. 22C) relating to the placement of the chambers in communication with the ambient is initiated if there is to be this mode of operation. However, when the system is operating under suction and pressure, there is no placement of the chambers in communication with the ambient, and therefore then the decision block therein on the main program is bypassed to subroutine C. When subroutine C (FIG. 22D) is executed, the Change Timer Setting block sets up the period of time that pressure will be applied to the chambers 73, 74 and 75 and thereafter the pressure timer is started. Therefore the signal is sent out from the PLC to each solenoid valve 188 associated with valve 159. The signal causes each solenoid valve to cause the flow of compressed air from the conduit 196 to the proper conduit 186 to shift the double acting pneumatic actuator 190 to shift its associated valve 159 to supply pressure to each chamber 73, 74 and 75, and the pressure is applied for the period that the timer is in operation. Thereafter, the subroutine C returns to the main program. Thereafter, the above-described series of executions are repeated.

As described above, when the system is set up as shown in FIG. 15, each of the chambers 73, 74 and 75 is treated identically by the alternate application of suction and pressure, in accordance with the above-described intelligence provided by the above-described system.

There are certain circumstances in which it will be desirable to operate the system by the simultaneous identical alternate application of suction and ambient to the three chambers. When this is desired, the conduit 161 is disconnected from between each of the pressure outlets of blowers 154 and each of the valves 159 so that the duct 165 (FIGS. 16 and 17) of each valve 159 previously in communication with the pressure outlet of each of the blowers is now open to the atmosphere. It will be appreciated that ambient may be effected in other ways, for example, by actuating a valve in each conduit 161 which routes the pressure to the atmosphere and opens the duct 165 of valve 159 to the atmosphere, or in any other suitable manner.

In order to alternately apply suction and ambient to each of the chambers 73, 74 and 75, the operator will input the mode of operation at the operator interface by means of a key pad or mouse to actuate the subroutine A in the above-described manner. Thereafter, the subroutine B relating to the application of ambient to the chambers will be actuated and this will set the timer setting for subroutine B to determine the length of time of exposure of each of the chambers to the ambient through each valve 159. Thereafter, the ambient period for each chamber will be started when a signal is sent from the PLC to the solenoid valve 188 associated with each double acting pneumatic cylinder 190, to actuate each valve 159 in the above described manner to place valve 159 in the position of FIG. 17, and the length of time will exist until the timer has finished, and thereafter there is a return to the main program wherein the entire sequence of subroutine A and subroutine B is repeated. The decision block 202 on the main program relating to pressure subroutine C will be bypassed when the operation is under suction and ambient.

The above description has shown how the four-way valves 159 can be actuated to provide identical simultaneous operation to each of the chambers 73, 74 and 75. However, it will be appreciated that each of the three chambers can be operated separately so that, for example, chamber 73 may not be subjected to suction or pressure and chamber 74 may be subjected only to suction and pressure and chamber 75 may be subjected to suction and ambient. The foregoing can be achieved by having three separate decision blocks of the type shown in the main program of FIG. 22A for each of the chambers and three separate subroutines A, B and C associated with each group of decision blocks. Thus, there will be three groups of three decision blocks, that is, one group of three decision blocks for each chamber and three subroutines for each decision block. Thus, there will be nine decision blocks and three subroutines A, three subroutines B and three subroutines C. If the foregoing is effected, there can be any desired type of operation applied to each of the three chambers. For example, it may be desirable to have the first two chambers 73 and 74 operating strictly by suction and pressure and have the exit chamber 75 operating by suction and ambient. Alternately, it may be desirable to operate one chamber under suction and pressure and the two of the other chambers by suction and ambient. Still alternately, it may be desirable to operate one chamber by suction and pressure, another chamber by suction and ambient and the third chamber without suction and pressure.

In addition to all of the foregoing, whether all chambers are being operated identically or differently, the periods of application of the suction, pressure or ambient may be varied by the operator through the PLC.

In FIG. 23 a deliquifying system 220 is disclosed for deliquifying the slurry of fine and coarse particles of varying sizes and liquid so that the coarse material will possess a relatively low content of liquid, which may consist of a mixture of oil and water. The system 220 includes a vibratory screening machine 221 which may have the same basic structure as vibratory screening machine 10 described above. A preferred embodiment of vibratory screening machine 221 has a plurality of screens 1, 2, 3 and 4 which receive a slurry of particles with varying sizes, including coarse particles, fine particles and liquid from conduit 222 leading from a drill or other source. While a preferred embodiment comprises four screens, other embodiments may comprise various numbers of screens, including three screens, as shown in the preceding figures. In a preferred embodiment, screens 1, 2 and 3, may be flat or undulating screens, and they do not have vacuum chambers associated therewith. In other embodiments, screens 1, 2, or 3 may include vacuum chambers. In a preferred embodiment, screen 4, which is preferably an undulating screen located at the outlet end 223 of the machine 221, comprises a vacuum chamber such as 75 described above associated therewith. The undulating screen 4 is preferred because it distributes the solids substantially uniformly across the screen as they pass toward the outlet end 223. The vibratory screen 221 may be operated between 3 G's and 12 G's. However, it should be operated at the G force which is most practical under the circumstances, which may possibly be higher than 12 G's. The incoming slurry from feed 222 passes progressively across screens 1, 2 and 3 toward exit end 223. The major part of the fine particles and liquid are separated from the slurry during passage over screens 1, 2 and 3, and they fall into drilling mud tank 224 from which they are conducted to the drill or other location through conduit 225.

In a preferred embodiment, suction in the range of 20-80 inches of water is applied to suction chamber 75, and this suction is intermittently released. This alternate application of suction and release of suction causes the coarse particles traveling along undulating screen 4 to have liquid and fine particles withdrawn therefrom, and they are dumped off of the vibratory screening machine into oversize container 227. The liquid and fine particles which are suctioned into vacuum chamber 75 exit from the plurality of duckbill valves 152 when there is a release of suction and vacuum chamber 75 returns to atmospheric pressure by atmospheric air passing through the screen overlying chamber 75. The liquid and fine particles which exit duckbill valves 152 are deposited into tank 224 along with the fine particles and liquid which pass through screens 1, 2 and 3. Alternately, the liquid and fine particles which exit duckbill valves 152 may be routed to a centrifuge or other processing equipment.

The alternate application and release of suction is applied to chamber 75 in the following manner. A blower 229 is in communication with chamber 75 via valve 230 in conduit 231, filter 232, conduit 233, cyclone separator 234, conduit 235, tee 237, valve 242 and conduit 239. Connected to tee 237 is a valve 241 that is open to the atmosphere. The control system 240 modulates valves 241 and 242 via connections 246 and 247, respectively. Control system 240 may also modulate valve 230 via connection 248. Connections 246, 247 and 248 may be pneumatic or electric connections, or any type of connection that allows control system 240 to change the position of valves 230, 241 and 242. When valve 242 is open, valve 241 is closed so that the suction produced by blower 229 is communicated to chamber 75. When it is desired to terminate the application of suction to chamber 75, valve 242 is closed and valve 241 is opened. When valve 242 is closed, atmospheric pressure will return to chamber 75 through the screen overlying chamber 75. When valve 241 is open, air will be supplied to blower 229 via conduit 235, cyclone separator 234, conduit 233, filter 232, conduit 231 and valve 230. The positions of valves 230, 241 and 242 can be modulated by control system 240 to create a desired amount of suction on chamber 75. In addition, the positions of valves 230, 241 and 242 can be modulated to control other process parameters, such as the load on blower 229.

The suction and venting cycles may be any desired amounts depending on the type and volume of material which is being passed over the vibratory screening machine and the G force applied to the slurry and the rate of conveyance of the slurry across screens 1, 2, 3 and 4 and the screen sizes which are being used and the type of screens, whether flat or undulating which comprise screens 1, 2 and 3. Preliminary test results have been satisfactory at cycles of approximately 2 to 3 seconds of suction and approximately 2 to 3 seconds of venting.

While screens 1, 2 and 3 may be of the flat or undulating type, screen 4 is preferably of the undulating type so as to pass the coarse material in rows longitudinally of the vibratory screening machine 221. While an undulating configuration is preferred, screen 4 may be of any type provided a sufficient depth of slurry covers it so as to maintain sufficient suction during suction cycles. If a portion of screen 4 is exposed to atmosphere, it may be difficult to maintain sufficient suction on chamber 75.

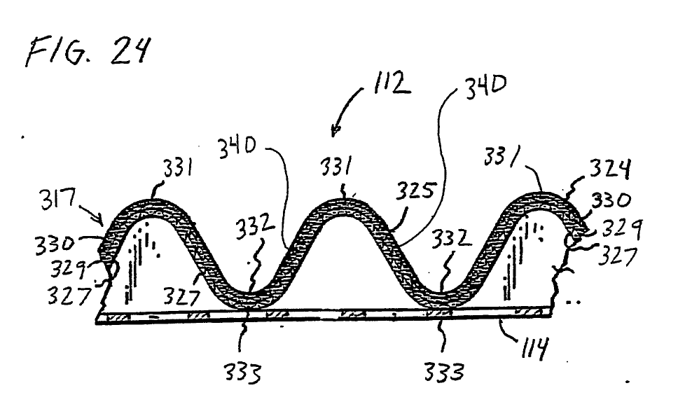

As previously stated, undulating screens are known in the art and are shown, for example, in U.S. Pat. No. 5,958,236, incorporated herein by reference. FIG. 24 shows a cross-section of an undulating screen 112. Undulating screen 112 has one or more layers of undulating screening material 317 formed to create peaks 331 and troughs 332 bonded to a perforated plate 114. Peaks 331 and troughs 332 extend generally parallel to one another.

As shown in FIG. 24, the plurality of layers of screening material which are secured to plate 114 are bonded together into a subassembly 325 by a perforated plastic grid 324 which has been fused into the screen layers by suitable heat and pressure. Thus, the screen subassembly 325 includes a coarse screen 327 which serves a supporting function and may have a size of between 6 mesh and 20 mesh or any other suitable size. A fine screening screen 329 is bonded to coarse supporting screen 327 and it may have a mesh size of between 30 mesh and 325 mesh, or any other suitable size. A finer screening screen 330 is bonded to fine screening screen 329 and it may have a mesh size of between 40 mesh and 400 mesh, or any other suitable size. Preferably the intermediate fine screen 329 should be two U.S. sieve sizes coarser than the finer uppermost screen 330. The three screens 327, 329 and 330 are bonded to each other by a fused plastic grid 324 which permeates all three screens. The screen subassembly 325 is formed in an undulating curved shape, as depicted in FIG. 24, and it has ridges or peaks 331, sides 340 and troughs 332. Sides 340 are generally planar surfaces which extend between peaks 331 and troughs 332. The undersides of troughs 332 at 333 are bonded to plate 114 by a suitable adhesive such as epoxy.

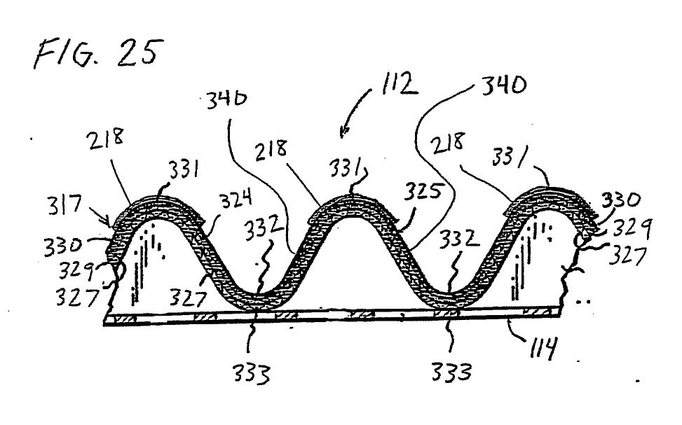

In a preferred embodiment shown in FIG. 25, screen 112 is an undulating screen with the tops of the screen peaks 331 coated with a coating 218 to close off the openings otherwise present between the intersections of the individual wires forming the screen openings. In other embodiments, a portion of sides 340 may also be coated with coating 218. As shown in FIG. 25, the coating 218 serves to seal the screens 112 at peaks 331. In this embodiment, coating 218 is preferably an epoxy such as Devcon 5-minute Epoxy Gel Resin. Coating 218 may be applied in any manner in which the screen peaks 331 are coated and the troughs 332 are not coated. The Devcon 5-minute Epoxy Gel Resin is a two part epoxy that may be mixed as it is applied with an applicator gun (not shown).

In a preferred method of application, the troughs 332 and sides 340 are covered with tape (not shown) to mask troughs 332 and sides 340 and thereby prevent coating 218 from covering troughs 332 or sides 340 of screen 112 while coating 218 is applied to the exposed portions (i.e., peaks 331) of screen 112. After coating 218 has sufficiently dried, the tape can then be removed from screen 112, thereby exposing the portions of screen 112 that are not intended to be covered with coating 218. Other sealants or coatings may be employed other than epoxy; however, it should be understood that the coating will be required to withstand the rigors of the environment in which screen 112 is employed. For use with vibrating screens used for solids separation in drilling applications, epoxy performs satisfactorily due to its ability to retain its sealing properties even when exposed to hot, solvent-laden drilling fluid, and when subjected to relatively high G-forces.

Applying coating 218 as shown in FIG. 25 greatly restricts the amount of air that can be passed through peaks 331 of screen 112. Applying coating 218 as shown also allows a suction or vacuum to be maintained on chamber 75 (shown in FIG. 23) with a reduced slurry volume, as discussed below.

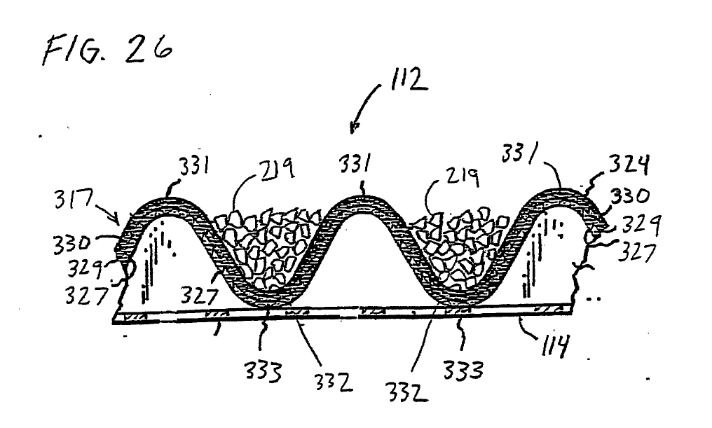

Referring to FIG. 26, if screen 112 has peaks 331 that are not coated and the level or depth of slurry 219 becomes reduced, then peaks 331 will be exposed to the atmosphere. This will allow excessive amounts of air to flow through peaks 331 and make it very difficult to maintain a desired level of vacuum on chamber 75 (shown in FIG. 23).

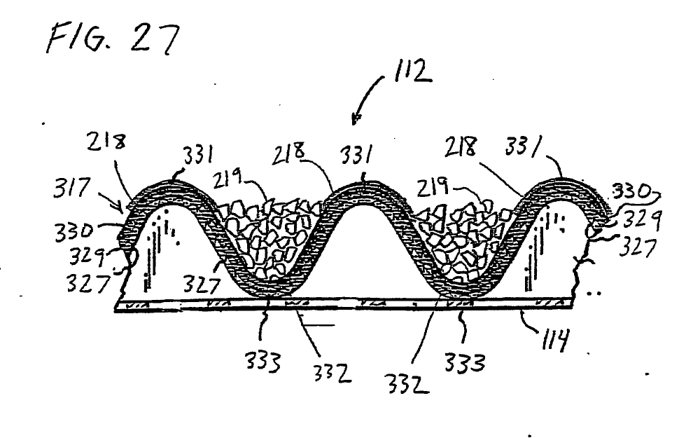

As shown in FIG. 27, coating 218 on peaks 331 seals off the exposed portions of screen 112 (those portions that are not covered by slurry 219, i.e. peaks 331). By sealing screen peaks 331, the level or depth of slurry 219 that must be maintained to produce a desired suction on chamber 75 is reduced because the screen peaks 331 do not have to be covered by slurry 219. Instead, the screen peaks 331 are sealed with coating 218 which prevents excessive amounts of air from flowing through peaks 331. This restriction in air flow allows a desirable level of suction or vacuum to be placed on chamber 75 (shown in FIG. 23).

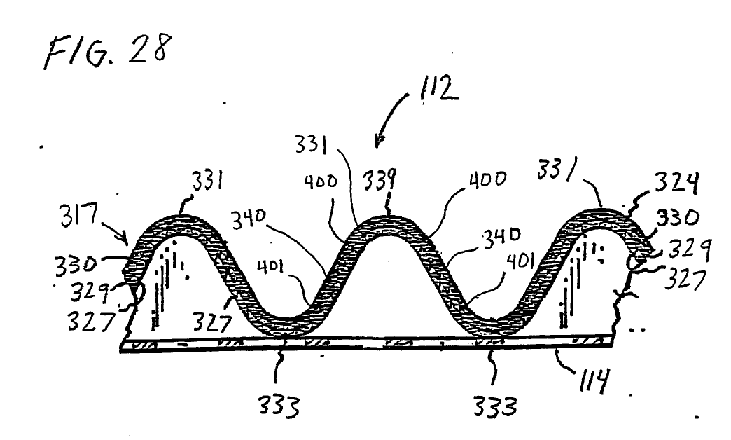

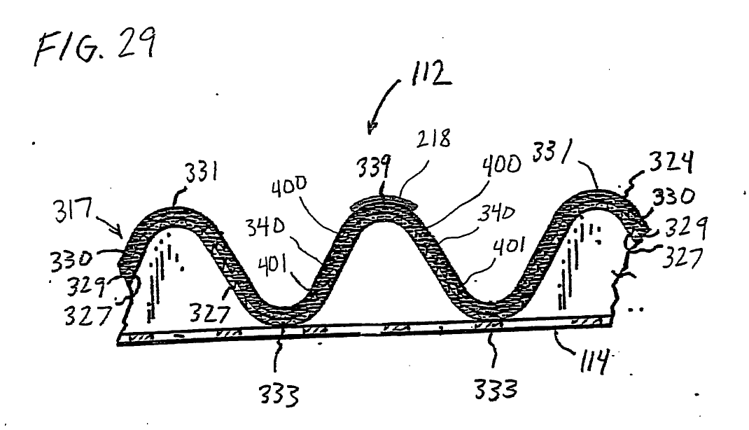

As shown in FIG. 28, screen peak 331 comprises a curved portion of the screen and includes apex 339. Screen peak 331 extends between upper transition points 400. At upper transition points 400, screen 112 transitions to a generally planar surface comprising side 340. Side 340 extends from upper transition point 400 to lower transition point 401. At lower transition point 401, screen 112 transitions to a curved portion comprising trough 333.

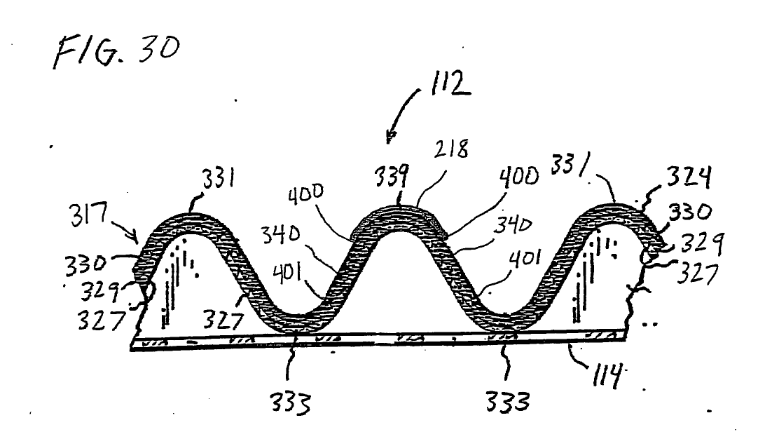

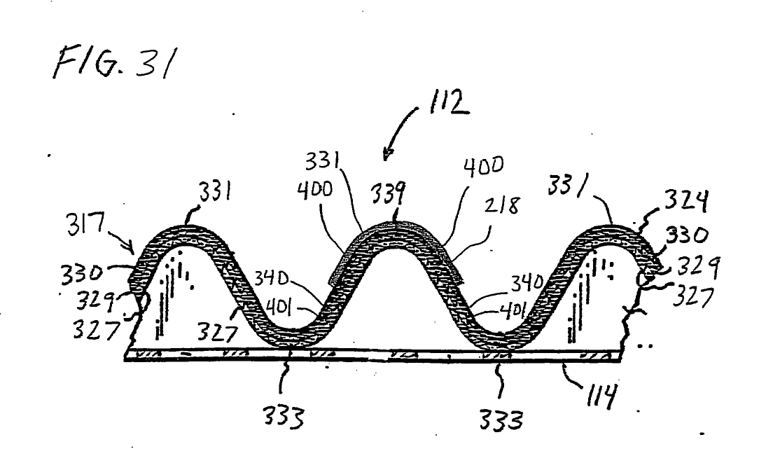

In various embodiments of the present invention, different portions of screen peak 331 and side 340 may be covered or sealed with coating 218. For example, in FIG. 29, one-half of the portion of peak 331 between apex 339 and upper transition point 400 is sealed with coating 218. In FIG. 30, the entire portion of peak 331 between apex 339 and upper transition point 400 is sealed with coating 218. In FIG. 31, coating 218 extends from apex 339 to beyond upper transition point 400. In the embodiment of FIG. 31, approximately one-half of the portion between upper transition point 400 and lower transition point 401 is sealed with coating 218. While exemplary embodiments of the present invention are shown in FIGS. 29-31, other embodiments may comprise different portions of screen peak 331 and side 340 being covered or sealed with coating 218.

Referring again to FIG. 23, during the suction cycle of chamber 75, airborne liquid and fine particles are passed to cyclone separator 234 wherein liquid and fine particles are separated from the air stream and deposited into tank 249 from which they are pumped by pump 250 through conduit 251 to tank 224. While cyclone separator 234 is shown in a preferred embodiment, any type of separator capable of separating particles and liquid from the air stream may be used. Alternately, the liquid and fine particles which exit tank 249 may be routed to a centrifuge or other processing equipment. Any remaining fine particles and liquid which pass beyond cyclone separator 234 through conduit 233 are removed from the air stream by filter 232 to thereby protect blower 229 from such contaminants.

If desired, a second vibratory screening machine, such as 221, may be connected via conduit (not shown, but analogous to conduit 239) to valve 241. Thus, when valve 242 is closed and valve 241 is open, suction will be applied to the vacuum chamber of the second vibratory screening machine which corresponds to suction chamber 75 of machine 221. The mode of operation of the second vibratory screening machine and the entire system will be equivalent to that described above relative to machine 221.

While the above description has been directed primarily to the recovery of drilling mud and drying coarse material, it will be appreciated that the above described apparatus and methods can be used in any application where it is desired to separate fine material and liquid from a slurry and also dry the non-separated material.

While preferred embodiments of the present invention have been disclosed, it will be appreciated that the invention is not limited thereto but may be otherwise embodied within the scope of the following claims.

1. A screen assembly comprising:
a support having upper and lower surfaces and a plurality of apertures extending between said upper and lower surfaces;
a screen formed in an undulating shape comprising a plurality of peaks, with troughs formed between said peaks, said screen attached to said upper surface of said support such that said peaks are spaced apart from said upper surface of said support; and
wherein at least one peak comprises a coating on a portion of the at least one peak, said coating sealing said screen to restrict the passage of air through said coated portion of the at least one peak.

2. The screen assembly of claim 1 further comprising:
a plurality of sides between said peaks and said troughs;
an apex on the at least one peak;
upper transition points between the at least one peak and said sides; and
wherein said coating on the at least one peak seals at least one-fourth of the portion of the at least one peak between said apex and said upper transition points.

3. The screen assembly of claim 1 further comprising:
a plurality of sides between said peaks and said troughs;
an apex on the at least one peak;
upper transition points between the at least one peak and said sides; and
wherein said coating on the at least one peak seals less than one-half of the portion of the at least one peak between said apex and said upper transition points.

4. A screen assembly comprising:
a support having upper and lower surfaces and a plurality of apertures extending between said upper and lower surfaces;
a screen layer formed in an undulating shape comprising a plurality of peaks, with troughs formed between said peaks and sides formed between said peaks and said troughs, said screen layer attached to said upper surface of said support such that said peaks are spaced apart from said upper surface of said support; and
wherein at least one peak comprises a coating on a portion of the at least one peak, said coating sealing said screen to restrict the passage of air through said coated portion of the at least one peak.

5. The screen assembly of claim 4 further comprising:
an apex on the at least one peak;
upper transition points between the at least one peak and said sides; and
wherein said coating on the at least one peak seals at least one-fourth of the portion of the at least one peak between said apex and said upper transition points.

6. The screen assembly of claim 4 further comprising:
an apex on the at least one peak;
upper transition points between the at least one peak and said sides; and
wherein said coating on the at least one peak seals less than one-half of the portion of the at least one peak between said apex and said upper transition points.

7. The screen assembly of claim 4, wherein at least one side comprises a coating on a portion of the at least one side.

8. The screen assembly of claim 7 further comprising:
lower transition points between the at least one side and said troughs;
wherein said coating on the at least one side seals at least one-fourth of the portion of the at least one side between said upper transition points and said lower transition points.

9. The screen assembly of claim 7 further comprising:
lower transition points between the at least one side and said troughs;
wherein said coating on the at least one side seals less than one-half of the portion of the at least one side between said upper transition points and said lower transition points.

10. An apparatus for screening material comprising:
a frame;
a motor mounted to said frame and adapted for supplying vibration to said frame;
a screen assembly supported by said frame;
a chamber beneath said screen assembly adapted to be intermittently subjected to a suction;
wherein said screen assembly comprises: a support having upper and lower surfaces and a plurality of apertures extending between said upper and lower surfaces;
a screen formed in an undulating shape comprising a plurality of peaks, with troughs formed between said peaks, said screen attached to said upper surface of said support such that said peaks are spaced apart from said upper surface of said support; and
wherein at least one peak comprises a coating on a portion of the at least one peak, said coating sealing said screen to restrict the passage of air through said coated portion of the at least one peak.

11. The apparatus of claim 10 further comprising:
a plurality of sides between said peaks and said troughs;
an apex on the at least one peak;
upper transition points between the at least one peak and said sides; and
wherein said coating on the at least one peak seals at least one-fourth of the portion of the at least one peak between said apex and said upper transition points.

12. The apparatus of claim 10 further comprising:
a plurality of sides between said peaks and said troughs;
an apex on the at least one peak;
upper transition points between the at least one peak and said sides; and
wherein said coating on the at least one peak seals less than one-half of the portion of the at least one peak between said apex and said upper transition points.

13. The apparatus of claim 11, wherein at least one side comprises a coating on a portion of the at least one side.

14. The apparatus of claim 11 further comprising:
lower transition points between the at least one side and said troughs;
wherein said coating on the at least one side seals at least one-fourth of the portion of the at least one side between said upper transition points and said lower transition points.

15. The apparatus of claim 11 further comprising:
lower transition points between the at least one side and said troughs;
wherein said coating on the at least one side seals less than one-half of the portion of the at least one side between said upper transition points and said lower transition points.

16. A method of manufacturing a screen assembly comprising the steps of:
providing a support having upper and lower surfaces and a plurality of apertures extending between said upper and lower surfaces;
providing a screen formed in an undulating shape comprising a plurality of peaks, with troughs formed between said peaks, attaching said screen to said upper surface of said support such that said peaks are spaced apart from said upper surface of said support; and
sealing a portion of at least one peak with a coating, said coating sealing said screen to restrict the passage of air through said coated portion of the at least one peak.

17. The method of claim 16 further comprising:
an apex on the at least one peak;
upper transition points between the at least one peak and said sides; and
wherein said coating on the at least one peak seals at least one-fourth of the portion of the at least one peak between said apex and said upper transition points.

18. The method of claim 16 further comprising:
an apex on the at least one peak;
upper transition points between the at least one peak and said sides; and
wherein said coating on the at least one peak seals less than one-half of the portion of the at least one peak between said apex and said upper transition points.

19. A method of manufacturing a screen assembly comprising the steps of:
providing a support having upper and lower surfaces and a plurality of apertures extending between said upper and lower surfaces;
providing a screen formed in an undulating shape comprising a plurality of peaks, with troughs formed between said peaks and sides formed between said peaks and said troughs;
attaching said screen to said upper surface of said support such that said peaks are spaced apart from said upper surface of said support; and
sealing a portion of at least one peak and a portion of at least one side with a coating, said coating sealing said screen to restrict the passage of air through said coated portions of the at least one peak and the at least one side.

20. The method of claim 19 further comprising:
an apex on the at least one peak;
upper transition points between the at least one peak and said sides;
lower transition points between the at least one side and said troughs; and
wherein said coating on the at least one side seals at least one-fourth of the portion of the at least one side between said upper transition points and said lower transition points.

21. The method of claim 19 further comprising:
an apex on the at least one peak;
upper transition points between the at least one peak and said sides;
lower transition points between the at least one side and said troughs; and
wherein said coating on the at least one side seals less than one-half of the portion of the at least one side between said upper transition points and said lower transition points.

22. A method of screening a slurry comprising the steps of:
conveying a slurry comprising particles and liquid across a screen comprising peaks and troughs, wherein at least one of the peaks are coated with a coating to restrict the passage of air through said coated portion;
vibrating said slurry on said screen;
applying suction from below said screen drawing air and particles and liquid through openings in said screen;
conveying said particles and said liquid to a separator; and
separating a portion of said particles and said liquid from air.
